(19) United States
(12) Patent Application Publication
(10) Pub. No.: US 2016/0191958 A1
(43) Pub. Date: Jun. 30, 2016

(54) Systems and methods of providing contextual features for digital communication

(71) Applicant: Krush Technologies, LLC, Dayton, OH (US)

(72) Inventors: John P. Nauseef, Kettering, OH (US); Christopher S. Wire, Dayton, OH (US); Brian T. Faust, Springboro, OH (US); Matthew J. Farrell, Springboro, OH (US); Patrick M. Murray, Dayton, OH (US); Linsey Ann Free, Chillicothe, OH (US); Gary T. Riggins, Dayton, OH (US); John C. Nesbitt, Tipp City, OH (US); Dustin L. Clinard, Dayton, OH (US)

(73) Assignee: Krush Technologies, LLC, Dayton, OH (US)

(21) Appl. No.: 14/980,769

(22) Filed: Dec. 28, 2015

Related U.S. Application Data
(60) Provisional application No. 62/096,991, filed on Dec. 26, 2014.

(51) Int. Cl. H04N 21/234; H04N 21/235; G10L 25/90; G06K 9/00; G10L 25/57; H04N 21/233; H04N 21/81

(52) U.S. Cl. CPC H04N 21/23418; H04N 21/233; H04N 21/235; H04N 21/8146; G06K 9/00744; G06K 9/00335; G06K 9/00268; G10L 25/57; G10L 25/90

(57) ABSTRACT

Embodiments disclosed herein may be directed to a video communication server for: receiving, using a communication unit comprised in at least one processing device, video content of a video communication connection between a first user of a first user device and a second user of a second user device; analyzing, using a graphical processing unit (GPU) comprised in the at least one processing device, the video content in real time; identifying, using a recognition unit comprised in the at least one processing device, at least one object of interest comprised in the video content; identifying, using a features unit comprised in the least one processing device, at least one contextual feature associated with the at least one identified object of interest; and presenting, using an input/output (I/O) device, the at least one contextual feature to at least one of the first user device and the second user device.

### CROSS REFERENCE TO RELATED APPLICATION

This application is a nonprovisional application of, and claims priority to, U.S. Provisional Patent Application No. 62/096,991 filed on Dec. 26, 2014, the disclosure of which is hereby incorporated by reference in its entirety.

### TECHNICAL FIELD

Embodiments disclosed herein relate to systems and methods of providing contextual features for digital communications.

### BACKGROUND

Today, digital communications technologies enable people across the world to generate and maintain relationships with others like never before. For example, a person may utilize digital communications technologies to meet people who live nearby, or to connect with others on the other side of the globe. Different digital communications technologies enable people to communicate with others through a variety of communication channels such as text messaging, audio messaging, picture sharing, and/or live video streaming. There is great opportunity for development of enhancements to be applied to conversations enabled by digital communications technologies.

### SUMMARY

Briefly, aspects of the present invention relate to intelligent enhancement of digital communication experiences through the use of facial gesture recognition and audio-visual analysis techniques described herein. In some embodiments, a video communication server is provided. The video communication server may comprise: at least one memory comprising instructions; and at least one processing device configured for executing the instructions, wherein the instructions cause the at least one processing device to perform the operations of: receiving, using a communication unit comprised in the at least one processing device, video content of a video communication connection between a first user of a first user device and a second user of a second user device; analyzing, using a graphical processing unit (GPU) comprised in the at least one processing device, the video content in real time; identifying, using a recognition unit comprised in the at least one processing device, at least one object of interest comprised in the video content; identifying, using a features unit comprised in the least one processing device, at least one contextual feature associated with the at least one identified object of interest; and presenting, using an input/output (I/O) device, the at least one contextual feature to at least one of the first user device and the second user device.

In some embodiments, the at least one object of interest comprises at least one of a facial feature, a facial gesture, a vocal inflection, a vocal pitch shift, a change in word delivery speed, a keyword, an ambient noise, an environment noise, a landmark, a structure, a physical object, and a detected motion.

In some embodiments, identifying the at least one object of interest comprises: identifying, using the recognition unit, a facial feature of the first user in the video content at a first time; identifying, using the recognition unit, the facial feature of the first user in the video content at a second time; and determining, using the recognition unit, movement of the facial feature from a first location at a first time to a second location at a second time, wherein the determined movement of the facial feature comprises a gesture associated with a predetermined emotion, and wherein the at least one contextual feature is associated with the predetermined emotion.

In some embodiments, identifying the at least one object of interest comprises: identifying, using the recognition unit, a first vocal pitch of the first user in the video content at a first time; identifying, using the recognition unit, a second vocal pitch of the first user in the video content at a second time; and determining, using the recognition unit, a change of vocal pitch of the first user, wherein the determined change of vocal pitch comprises a gesture associated with a predetermined emotion, and wherein the at least one contextual feature is associated with the predetermined emotion.

In some embodiments, identifying the at least one object of interest comprises: identifying, using the recognition unit, a landmark in the video content, wherein the landmark is associated with a geographic region; identifying, using the recognition unit, a speaking accent of the first user in the video content, wherein the accent is associated with the geographic region; and determining, using the recognition unit and based at least in part on the landmark and the accent, the first user device is located in the geographic region, wherein the at least one contextual feature is associated with the geographic region.

In some embodiments, presenting the at least one contextual feature to at least one of the first user device and the second user device comprises: identifying, using the recognition unit, at least one reference point in the video content; tracking, using the recognition unit, movement of the at least one reference point in the video content; and overlaying, using the features unit, the at least one contextual feature onto the at least one reference point in the video content.

In some embodiments, identifying the at least one object of interest comprises: determining, using the GPU, a numerical value of at least one pixel associated with the at least one object of interest.

In some embodiments, a non-transitory computer readable medium is provided. The non-transitory computer readable medium may comprise code, wherein the code, when executed by at least one processing device of a video communication server, causes the at least one processing device to perform the operations of: receiving, using a communication unit comprised in the at least one processing device, video content of a video communication connection between a first user of a first user device and a second user of a second user device; analyzing, using a graphical processing unit (GPU) comprised in the at least one processing device, the video content in real time; identifying, using a recognition unit comprised in the at least one processing device, at least one object of interest comprised in the video content; identifying, using a features unit comprised in the least one processing device, at least one contextual feature associated with the at least one identified object of interest; and presenting, using an input/output (I/O) device, the at least one contextual feature to at least one of the first user device and the second user device.

In some embodiments, the non-transitory computer readable medium further comprises code that, when executed by the at least one processing device of the video communication server, causes the at least one processing device to perform the operations of: identifying, using the recognition unit, a facial feature of the first user in the video content at a first time; identifying, using the recognition unit, the facial feature of the first user in the video content at a second time; and determining, using the recognition unit, movement of the facial feature from a first location at a first time to a second location at a second time, wherein the determined movement of the facial feature comprises a gesture associated with a predetermined emotion, and wherein the at least one contextual feature is associated with the predetermined emotion.

In some embodiments, the non-transitory computer readable medium further comprises code that, when executed by the at least one processing device of the video communication server, causes the at least one processing device to perform the operations of: identifying, using the recognition unit, a first vocal pitch of the first user in the video content at a first time; identifying, using the recognition unit, a second vocal pitch of the first user in the video content at a second time; and determining, using the recognition unit, a change of vocal pitch of the first user, wherein the determined change of vocal pitch comprises a gesture associated with a predetermined emotion, and wherein the at least one contextual feature is associated with the predetermined emotion.

In some embodiments, the non-transitory computer readable medium further comprises code that, when executed by the at least one processing device of the video communication server, causes the at least one processing device to perform the operations of: identifying, using the recognition unit, a landmark in the video content, wherein the landmark is associated with a geographic region; identifying, using the recognition unit, a speaking accent of the first user in the video content, wherein the accent is associated with the geographic region; and determining, using the recognition unit and based at least in part on the landmark and the accent, the first user device is located in the geographic region, wherein the at least one contextual feature is associated with the geographic region.

In some embodiments, the non-transitory computer readable medium further comprises code that, when executed by the at least one processing device of the video communication server, causes the at least one processing device to perform the operations of: identifying, using the recognition unit, at least one reference point in the video content; tracking, using the recognition unit, movement of the at least one reference point in the video content; and overlaying, using the features unit, the at least one contextual feature onto the at least one reference point in the video content.

In some embodiments, the non-transitory computer readable medium further comprises code that, when executed by the at least one processing device of the video communication server, causes the at least one processing device to perform the operations of: determining, using the GPU, a numerical value of at least one pixel associated with a facial feature identified in the video content.

In some embodiments, a method is provided. The method may comprise: receiving, using a communication unit comprised in at least one processing device, video content of a video communication connection between a first user of a first user device and a second user of a second user device; analyzing, using a graphical processing unit (GPU) comprised in the at least one processing device, the video content in real time; identifying, using a recognition unit comprised in the at least one processing device, at least one object of interest comprised in the video content; identifying, using a features unit comprised in the least one processing device, at least one contextual feature associated with the at least one identified object of interest; and presenting, using an input/output (I/O) device, the at least one contextual feature to at least one of the first user device and the second user device.

In some embodiments, the method further comprises: identifying, using the recognition unit, a facial feature of the first user in the video content at a first time; identifying, using the recognition unit, the facial feature of the first user in the video content at a second time; and determining, using the recognition unit, movement of the facial feature from a first location at a first time to a second location at a second time, wherein the determined movement of the facial feature comprises a gesture associated with a predetermined emotion, and wherein the at least one contextual feature is associated with the predetermined emotion.

In some embodiments, the method further comprises: identifying, using the recognition unit, a first vocal pitch of the first user in the video content at a first time; identifying, using the recognition unit, a second vocal pitch of the first user in the video content at a second time; and determining, using the recognition unit, a change of vocal pitch of the first user, wherein the determined change of vocal pitch comprises a gesture associated with a predetermined emotion, and wherein the at least one contextual feature is associated with the predetermined emotion.

In some embodiments, the method further comprises: identifying, using the recognition unit, a landmark in the video content, wherein the landmark is associated with a geographic region; identifying, using the recognition unit, a speaking accent of the first user in the video content, wherein the accent is associated with the geographic region; and determining, using the recognition unit and based at least in part on the landmark and the accent, the first user device is located in the geographic region, wherein the at least one contextual feature is associated with the geographic region.

In some embodiments, the method further comprises: identifying, using the recognition unit, at least one reference point in the video content; tracking, using the recognition unit, movement of the at least one reference point in the video content; and overlaying, using the features unit, the at least one contextual feature onto the at least one reference point in the video content.

### BRIEF DESCRIPTION OF THE DRAWINGS

Reference is now made to the following detailed description, taken in conjunction with the accompanying drawings. It is emphasized that various features may not be drawn to scale and the dimensions of various features may be arbitrarily increased or reduced for clarity of discussion. Further, some components may be omitted in certain figures for clarity of discussion.

FIG. 1 shows an exemplary video communication connection between two users, in accordance with some embodiments of the disclosure;

FIG. 2 shows an exemplary system environment, in accordance with some embodiments of the disclosure;

FIG. 3 shows an exemplary computing environment, in accordance with some embodiments of the disclosure;

FIG. 4 shows an exemplary presentation of contextual features to a user based on an identified emotion of a user, in accordance with some embodiments of the disclosure;

FIG. 5 shows an exemplary presentation of an avatar contextual feature to a user, in accordance with some embodiments of the disclosure;

FIG. 6 shows an exemplary presentation of contextual features to a user based on an identified location of a user, in accordance with some embodiments of the disclosure;

FIG. 7 shows an exemplary method of performing operations associated with identifying contextual features based on emotion, in accordance with some embodiments of the disclosure; and

FIG. 8 shows an exemplary method of performing operations associated with identifying contextual features based on location, in accordance with some embodiments of the disclosure.

### DETAILED DESCRIPTION

### Introduction

Embodiments of the present disclosure may be directed to a system that enables incorporation of contextual features into a video communication connection between two or more users of two or more respective user devices. In addition to providing a video communication channel via which the two users may communicate, the system may enable real-time analysis of video content (e.g., a live video feed, a live audio feed, and/or the like) transmitted between the user devices during the video communication connection. Based on analysis of video content, the system may identify various emotional cues such as facial gestures, vocal inflections, and/or other displays of emotion of each user. The system may also identify various locational cues included in the video content, such as recognizable landmarks in the background of a live video feed of a user, to determine a location of each user. The system may then identify contextual features (e.g., icons, images, text, avatars, and/or the like) that correspond to each user's identified emotions and/or determined location and are therefore relevant to the video communication connection. These identified contextual features may be presented to each user so that one or more contextual features may be selected for incorporation (e.g., overlay) into the video communication connection. In this manner, emotional intelligence associated with a user's expressed emotions and/or locational intelligence associated with a user's location may be utilized to provide users with relevant contextual features for incorporation into the video communication connection experience to thereby enhance the video communication connection experience.

### Illustrative Example

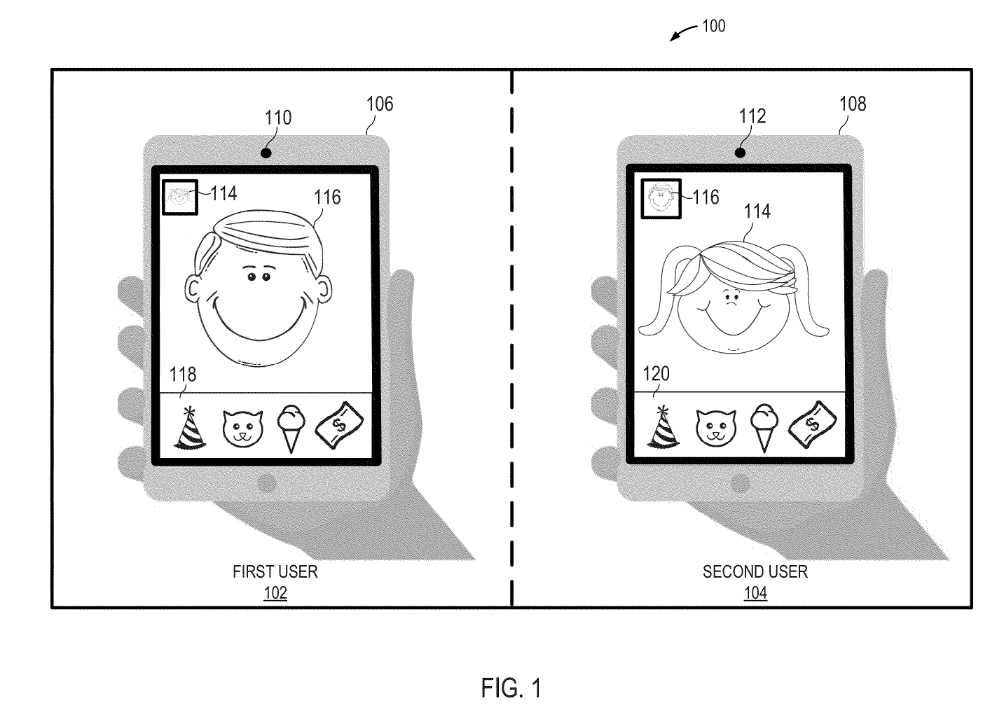

Referring now to the Figures, FIG. 1 illustrates an exemplary video communication connection 100 for enabling a video communication between a first user 102 and a second user 104. For example, each of the first user 102 and the second user 104 may hold a user device (e.g., a first user device 106 and a second user device 108, respectively) in front of his or her face so that a camera 110, 112 (e.g., a sensor) included in each respective user device 106, 108 may capture a live video feed of each user's face (e.g., the first user's face 114 and/or the second user's face 116). Audio of each user may also be captured by a microphone (not pictured) included in each user device 106, 108. The first user's face 114 may be presented to the second user 104 on the second user device 108, as well as on the first user device 106 for monitoring purposes. Similarly, the second user's face 116 may be presented to the first user 102 on the first user device 106, as well as on the second user device 108 for monitoring purposes. Additionally, contextual features (e.g., icons, images, text, background images, overlay images, and/or the like) 118, 120 associated with the first user 102 and the second user 104 may be provided in a heads-up display on the first user device 106 and the second user device 108, respectively.

A video communication server (not pictured) facilitating the video communication connection may analyze the live video and/or audio feeds of the users 102, 104 that are transmitted during the video communication connection. Analyzing the live video and/or audio feeds may enable the server to detect facial features of each user 102, 104, as well as any speech characteristics of each user's speech. The facial features and/or speech characteristics identified during analysis of the video communication connection may be used to identify emotional cues, such as facial gestures or vocal inflections, of each user 102, 104 that are associated with predetermined emotions. In some embodiments, emotional cues may be identified by the server using a variety of video analysis techniques including comparisons of pixels, comparisons of facial feature locations over time, detection of changes in vocal pitch, and/or the like. For example, the server may identify emotional cues of each user 102, 104 based on detected movements of facial features and/or changes in vocal pitch or tone identified in the live video and/or audio feeds.

An exemplary emotional cue identification may include the server detecting raised eyebrows and a smile of the first user 102 based on an analysis of facial images transmitted during the video communication connection. The server may determine, based on a predetermined table and/or database of known emotional cues, that these detected emotional cues (e.g., raised eyebrows and smile) convey happiness.

Accordingly, the server may identify one or more contextual features 118, 120 (e.g., icons, emoticons, images, text, and/or the like) stored in a database that are associated with detected emotions of the participating users. For example, the server may identify in the database a set of images that are associated with positive, happy emotions. The server may then provide the set of contextual features 118, 120 to at least one of the users so that the contextual features may be selected for incorporation into the video communication connection. For example, based on detection of a first user's 102 smile and raised eyebrows, the server may provide to the first user device 106 a set of contextual features 118 associated with happiness, such as smiley face icons, a party hat, and/or the like. The first user 102 may then select one or more of the provided contextual features 118 to overlay the first user's 102 face in the video communication connection to enhance the happy emotions currently being experienced by the first user 102.

### System Environment

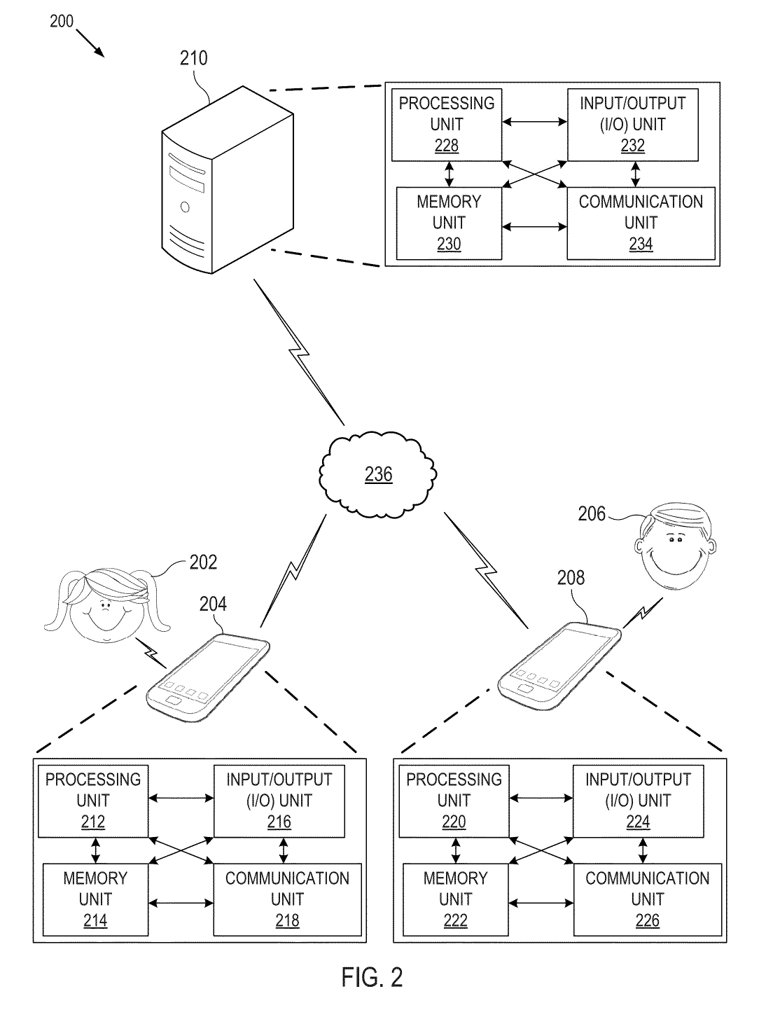

FIG. 2 illustrates an exemplary system 200 for enabling establishment of a video communication connection between a first user 202 of a first user device 204 and a second user 206 of a second user device 208 as described herein (e.g., as described in the illustrative example of FIG. 1). Additionally, the system 200 may enable establishment of a video communication connection between a plurality of first user devices 206 and/or second user devices 208. In this manner, the system 200 may enable a large number of users 202, 204 to participate in the video communication connection, such as in a conference call setting, a group video chat, and/or the like.

In some embodiments, the system 200 may include the first user device 204, the second user device 208, and a video communication server 210. In some embodiments, the first user device 204 and/or the second user device 208 may include a handheld computing device, a smart phone, a tablet, a laptop computer, a desktop computer, a personal digital assistant (PDA), a smart watch, a wearable device, a biometric device, an implanted device, a camera, a video recorder, an audio recorder, a touchscreen, a video communication server, and/or the like. In some embodiments, the first user device 204 and/or the second user device 208 may each include a plurality of user devices as described herein.

In some embodiments, the first user device 204 may include various elements of a computing environment as described herein. For example, the first user device 204 may include a processing unit 212, a memory unit 214, an input/output (I/O) unit 216, and/or a communication unit 218. Each of the processing unit 212, the memory unit 214, the input/output (I/O) unit 216, and/or the communication unit 218 may include one or more subunits as described herein for performing operations associated with providing relevant contextual features to the first user 202 during a video communication connection.

In some embodiments, the second user device 208 may include various elements of a computing environment as described herein. For example, the second user device 208 may include a processing unit 220, a memory unit 222, an input/output (I/O) unit 224, and/or a communication unit 226. Each of the processing unit 220, the memory unit 222, the input/output (I/O) unit 224, and/or the communication unit 226 may include one or more subunits as described herein for performing operations associated with providing relevant contextual features to the second user 206 during a video communication connection.

In some embodiments, the video communication server 210 may include a computing device such as a mainframe server, a content server, a communication server, a laptop computer, a desktop computer, a handheld computing device, a smart phone, a smart watch, a wearable device, a touch screen, a biometric device, a video processing device, an audio processing device, and/or the like. In some embodiments, the video communication server 210 may include a plurality of servers configured to communicate with one another and/or implement load-balancing techniques described herein.

In some embodiments, the video communication server 210 may include various elements of a computing environment as described herein. For example, the video communication server 210 may include a processing unit 228, a memory unit 230, an input/output (I/O) unit 232, and/or a communication unit 234. Each of the processing unit 228, the memory unit 230, the input/output (I/O) unit 232, and/or the communication unit 234 may include one or more subunits as described herein for performing operations associated with identifying relevant contextual features for presentation to one or more users (e.g., the first user 202 and/or the second user 206) during a video communication connection.

The first user device 204, the second user device 208, and/or the video communication sever 210 may be communicatively coupled to one another by a network 236 as described herein. In some embodiments, the network 236 may include a plurality of networks. In some embodiments, the network 236 may include any wireless and/or wired communications network that facilitates communication between the first user device 204, the second user device 208, and/or the video communication server 210. For example, the one or more networks may include an Ethernet network, a cellular network, a computer network, the Internet, a wireless fidelity (Wi-Fi) network, a light fidelity (Li-Fi) network, a Bluetooth network, a radio frequency identification (RFID) network, a near-field communication (NFC) network, a laser-based network, and/or the like.

### Computing Architecture

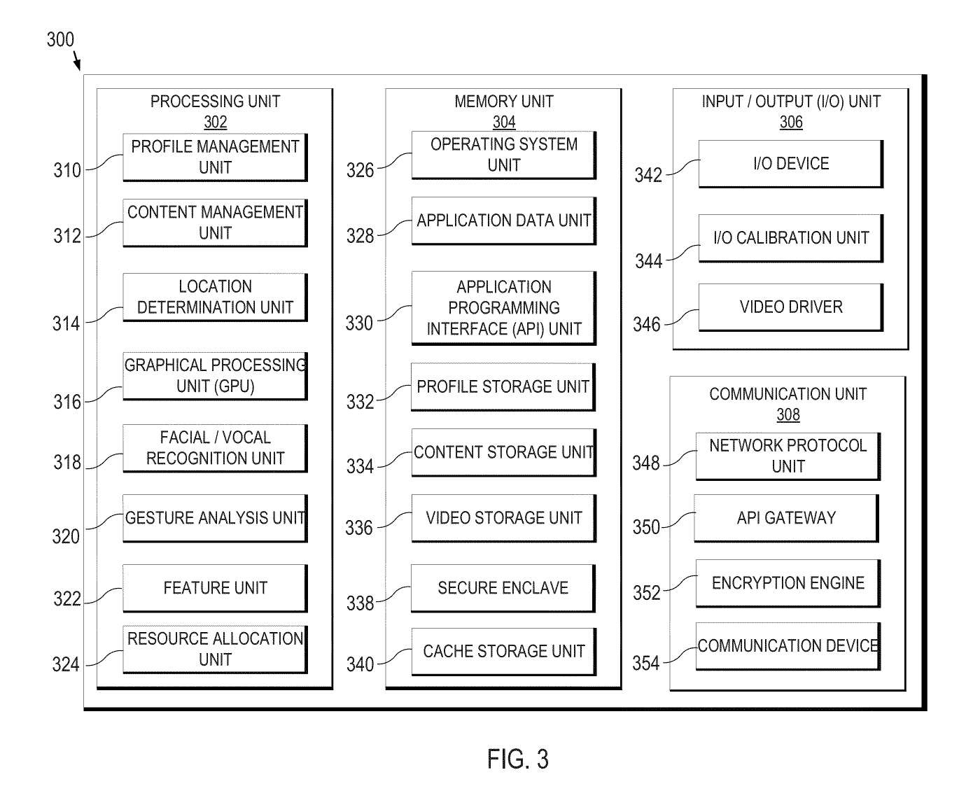

FIG. 3 illustrates an exemplary computing environment 300 for enabling the video communication connection and associated video processing techniques described herein. For example, the computing environment 300 may be included in and/or utilized by the first user device 106 and/or the second user device 108 of FIG. 1, the first user device 204, the second user device 208, and/or the video communication server 210 of FIG. 2, and/or any other device described herein. Additionally, any units and/or subunits described herein with reference to FIG. 3 may be included in one or more elements of FIG. 2 such as the first user device 202 (e.g., the processing unit 212, the memory unit 214, the I/O unit 216, and/or the communication unit 218), the second user device 206 (e.g., the processing unit 220, the memory unit 222, the I/O unit 224, and/or the communication unit 226), and/or the video communication server 210 (e.g., the processing unit 228, the memory unit 230, the I/O unit 232, and/or the communication unit 234). The computing environment 300 and/or any of its units and/or subunits described herein may include general hardware, specifically-purposed hardware, and/or software.

The computing environment 300 may include, among other elements, a processing unit 302, a memory unit 304, an input/output (I/O) unit 306, and/or a communication unit 308. As described herein, each of the processing unit 302, the memory unit 304, the I/O unit 306, and/or the communication unit 308 may include and/or refer to a plurality of respective units, subunits, and/or elements. Furthermore, each of the processing unit 302, the memory unit 304, the I/O unit 306, and/or the communication unit 308 may be operatively and/or otherwise communicatively coupled with each other so as to facilitate the video communication and analysis techniques described herein.

The processing unit 302 may control any of the one or more units 304, 306, 308, as well as any included subunits, elements, components, devices, and/or functions performed by the units 304, 306, 308 included in the computing environment 300. The processing unit 302 may also control any unit and/or device included in the system 200 of FIG. 2. Any actions described herein as being performed by a processor may be taken by the processing unit 302 alone and/or by the processing unit 302 in conjunction with one or more additional processors, units, subunits, elements, components, devices, and/or the like. Additionally, while only one processing unit 302 may be shown in FIG. 3, multiple processing units may be present and/or otherwise included in the computing environment 300. Thus, while instructions may be described as being executed by the processing unit 302 (and/or various subunits of the processing unit 302), the instructions may be executed simultaneously, serially, and/or by one or multiple processing units 302 in parallel.

In some embodiments, the processing unit 302 may be implemented as one or more computer processing unit (CPU) chips and/or graphical processing unit (GPU) chips and may include a hardware device capable of executing computer instructions. The processing unit 302 may execute instructions, codes, computer programs, and/or scripts. The instructions, codes, computer programs, and/or scripts may be received from and/or stored in the memory unit 304, the I/O unit 306, the communication unit 308, subunits and/or elements of the aforementioned units, other devices and/or computing environments, and/or the like. As described herein, any unit and/or subunit (e.g., element) of the computing environment 300 and/or any other computing environment may be utilized to perform any operation. Particularly, the computing environment 300 may not include a generic computing system, but instead may include a customized computing system designed to perform the various methods described herein.

In some embodiments, the processing unit 302 may include, among other elements, subunits such as a profile management unit 310, a content management unit 312, a location determination unit 314, a graphical processing unit (GPU) 316, a facial/vocal recognition unit 318, a gesture analysis unit 320, a features unit 322, and/or a resource allocation unit 324. Each of the aforementioned subunits of the processing unit 302 may be communicatively and/or otherwise operably coupled with each other.

The profile management unit 310 may facilitate generation, modification, analysis, transmission, and/or presentation of a user profile associated with a user. For example, the profile management unit 310 may prompt a user via a user device to register by inputting authentication credentials, personal information (e.g., an age, a gender, and/or the like), contact information (e.g., a phone number, a zip code, a mailing address, an email address, a name, and/or the like), and/or the like. The profile management unit 310 may also control and/or utilize an element of the I/O unit 306 to enable a user of the user device to take a picture of herself/himself. The profile management unit 310 may receive, process, analyze, organize, and/or otherwise transform any data received from the user and/or another computing element so as to generate a user profile of a user that includes personal information, contact information, user preferences, a photo, a video recording, an audio recording, a textual description, a virtual currency balance, a history of user activity, user preferences, settings, and/or the like.

The content management unit 312 may facilitate generation, modification, analysis, transmission, and/or presentation of media content. For example, the content management unit 312 may control the audio-visual environment and/or appearance of application data during execution of various processes. Media content for which the content management unit 312 may be responsible may include advertisements, images, text, themes, audio files, video files, documents, and/or the like. In some embodiments, the content management unit 312 may also interface with a third-party content server and/or memory location. Additionally, the content management unit 312 may be responsible for the identification, selection, and/or presentation of various contextual features for incorporation into the video communication connection as described herein. In some embodiments, contextual features may include icons, emoticons, images, text, audio samples, and/or video clips associated with one or more predetermined emotions.

The location determination unit 314 may facilitate detection, generation, modification, analysis, transmission, and/or presentation of location information. Location information may include global positioning system (GPS) coordinates, an Internet protocol (IP) address, a media access control (MAC) address, geolocation information, an address, a port number, a zip code, a server number, a proxy name and/or number, device information (e.g., a serial number), and/or the like. In some embodiments, the location determination unit 314 may include various sensors, a radar, and/or other specifically-purposed hardware elements for enabling the location determination unit 314 to acquire, measure, and/or otherwise transform location information.

The GPU unit 316 may facilitate generation, modification, analysis, processing, transmission, and/or presentation of visual content (e.g., media content described above). In some embodiments, the GPU unit 316 may be utilized to render visual content for presentation on a user device, analyze a live streaming video feed for metadata associated with a user and/or a user device responsible for generating the live video feed, and/or the like. The GPU unit 316 may also include multiple GPUs and therefore may be configured to perform and/or execute multiple processes in parallel.

The facial/vocal recognition unit 318 may facilitate recognition, analysis, and/or processing of visual content, such as a live video stream of a user's face. For example, the facial/vocal recognition unit 318 may be utilized for identifying facial features of users and/or identifying speech characteristics of users. In some embodiments, the facial/vocal recognition unit 318 may include GPUs and/or other processing elements so as to enable efficient analysis of video content in either series or parallel. The facial/vocal recognition unit 318 may utilize a variety of audio-visual analysis techniques such as pixel comparison, pixel value identification, voice recognition, audio sampling, video sampling, image splicing, image reconstruction, video reconstruction, audio reconstruction, and/or the like to verify an identity of a user, to verify and/or monitor subject matter of a live video feed, and/or the like.

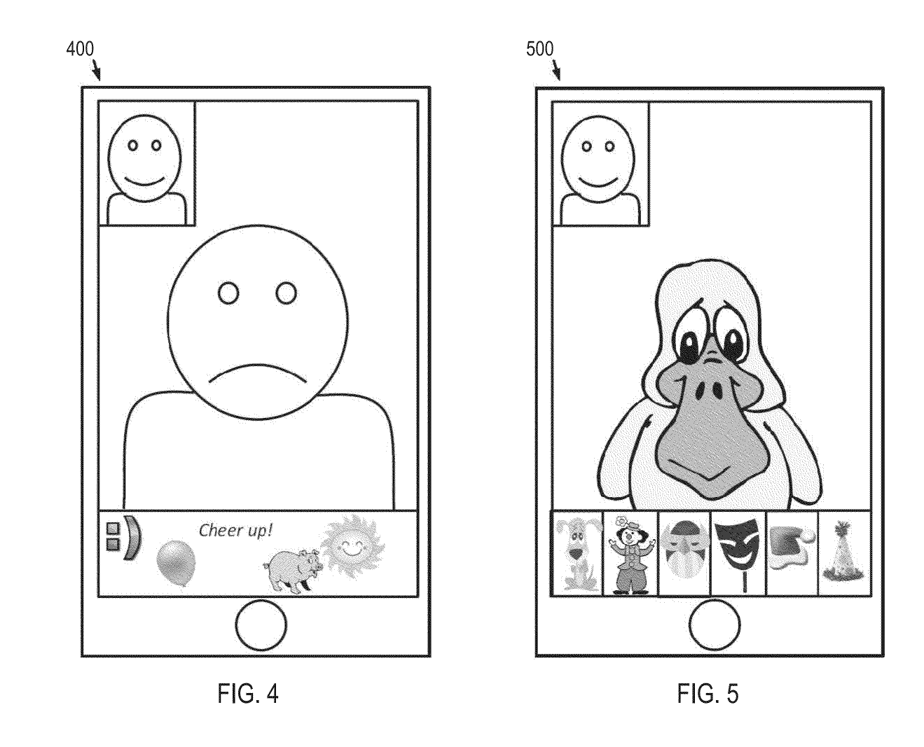

The gesture analysis unit 320 may facilitate recognition, analysis, and/or processing of visual content, such as a live video stream of a user's face. Similar to the facial/vocal recognition unit 318, the gesture recognition unit 320 may be utilized for identifying facial features of users and/or identifying vocal inflections of users. Further, however, the gesture analysis unit 320 may analyze movements and/or changes in facial features and/or vocal inflection identified by the facial/vocal recognition unit 318 to identify emotional cues of users. As used herein, emotional cues may include facial gestures such as eyebrow movements, eyeball movements, eyelid movements, ear movements, nose and/or nostril movements, lip movements, chin movements, cheek movements, forehead movements, tongue movements, teeth movements, vocal pitch shifting, vocal tone shifting, changes in word delivery speed, keywords, word count, ambient noise and/or environment noise, background noise, and/or the like. In this manner, the gesture analysis unit 320 may identify, based on identified emotional cues of users, one or more emotions currently being experienced by the users. For example, if the gesture analysis unit 320 may determine, based on identification of emotional cues associated with a frown (e.g., a furrowed brow, a frowning smile, flared nostrils, and/or the like), that a user is unhappy (see exemplary user interface 400 of FIG. 4). Predetermined emotions may include happiness, sadness, excitement, anger, fear, anger, discomfort, joy, envy, and/or the like and may also be associated with other detected user characteristics such as gender, age, and/or the like.

In some embodiments, the gesture analysis unit 320 may additionally facilitate analysis and/or processing of emotional cues and/or associated emotions identified by the gesture analysis unit 320. For example, the gesture analysis unit 320 may quantify identified emotional cues and/or intensity of identified emotional cues by assigning a numerical value (e.g., an alphanumeric character) to each identified emotional cue. In some embodiments, numerical values of identified emotional cues may be weighted and/or assigned a grade (e.g., an alphanumeric label such as A, B, C, D, F, and/or the like) associated with a perceived value and/or quality (e.g., an emotion) by the gesture analysis unit 320. In addition to assigning numerical values of identified emotional cues, the gesture analysis unit 320 may quantify and/or otherwise utilize other factors associated with the video communication connection such as a time duration of the video communication connection, an intensity of an identified emotional cue, and/or the like. For example, the gesture analysis unit 320 may assign a larger weight to an identified emotional cue that occurred during a video communication connection lasting one minute than an identified emotional cue that occurred during a video communication connection lasting thirty seconds. The gesture analysis unit 320 may determine appropriate numerical values based on a predetermined table of predefined emotional cues associated with emotions and/or a variety of factors associated with a video communication connection such as time duration, a frequency, intensity, and/or duration of an identified emotional cue, and/or the like.

The gesture analysis unit 320 may also facilitate the collection, receipt, processing, analysis, and/or transformation of user input received from user devices of users participating in a video communication connection. For example, the gesture analysis unit 320 may facilitate the prompting of a first participant in a video communication connection to provide feedback associated with emotions currently being experienced by one or more of the participating users. This feedback may be received, processed, weighted, and/or transformed by the gesture analysis unit 320.

The features unit 322 may utilize the numerical values of identified emotional cues, emotions, and/or other factors, as well as any received feedback (e.g., user inputs such as textual and/or numerical reviews and/or descriptions of emotions, and/or the like), to identify one or more contextual features to be presented to a user device for selection by the user. Alternatively, the features unit 322 may utilize the numerical values of identified emotional cues, emotions, and/or other factors, as well as any received feedback, to select one or more contextual features to be presented to the user. In some embodiments, the contextual features identified and/or selected by the features unit 322 may correspond to a detected emotional cue and/or emotion of a participating user of the video communication connection.

As such, the features unit 322 may facilitate presentation of contextual features associated with a user's perceived emotions to one or more users. For example, the features unit 322 may determine, based on an analysis of video and/or audio content of a first user transmitted during a video communication connection by the facial/vocal recognition unit 318 and/or the gestures unit 320, that the first user is frowning and thus experience a negative emotion. Accordingly, the features unit 322 may identify one or more contextual features (e.g., icons, text, images, audio samples, and/or the like) stored in the content storage unit 334 to be presented to a second user of the video communication connection. The features unit 322 may, using the communication unit 308, transmit the one or more identified contextual features to one or more user devices of users participating in the video communication connection. The user(s) may then select one or more of the contextual features, such as a smiley face icon, for overlay and/or incorporation into the video communication connection in an attempt to cheer up the first user who is determined to be frowning. For example, upon selection by a second user, a smiley face icon may be overlaid on top of an image of the first user's face in the video communication connection. In some embodiments, the features unit 322 may communicate with and/or otherwise utilize the content management unit 312, the content storage unit 344, and/or the I/O device 342 to generate, receive, retrieve, identify, and/or present the identified and/or selected features to one or more user device. In some embodiments, the features unit 322 may select one or more contextual features to be displayed during the video communication connection and/or presented to a user for a predetermined period of time.

The resource allocation unit 324 may facilitate the determination, monitoring, analysis, and/or allocation of computing resources throughout the computing environment 300 and/or other computing environments. For example, the computing environment 300 may facilitate a high volume of (e.g., multiple) video communication connections between a large number of supported users and/or associated user devices. As such, computing resources of the computing environment 300 utilized by the processing unit 302, the memory unit 304, the I/O unit, and/or the communication unit 308 (and/or any subunit of the aforementioned units) such as processing power, data storage space, network bandwidth, and/or the like may be in high demand at various times during operation. Accordingly, the resource allocation unit 324 may be configured to manage the allocation of various computing resources as they are required by particular units and/or subunits of the computing environment 300 and/or other computing environments. In some embodiments, the resource allocation unit 324 may include sensors and/or other specially-purposed hardware for monitoring performance of each unit and/or subunit of the computing environment 300, as well as hardware for responding to the computing resource needs of each unit and/or subunit. In some embodiments, the resource allocation unit 324 may utilize computing resources of a second computing environment separate and distinct from the computing environment 300 to facilitate a desired operation.

For example, the resource allocation unit 324 may determine a number of simultaneous video communication connections, a number of incoming requests for establishing video communication connections, a number of users to be connected via the video communication connection, and/or the like. The resource allocation unit 324 may then determine that the number of simultaneous video communication connections and/or incoming requests for establishing video communication connections meets and/or exceeds a predetermined threshold value. Based on this determination, the resource allocation unit 324 may determine an amount of additional computing resources (e.g., processing power, storage space of a particular non-transitory computer-readable memory medium, network bandwidth, and/or the like) required by the processing unit 302, the memory unit 304, the I/O unit 306, the communication unit 308, and/or any subunit of the aforementioned units for enabling safe and efficient operation of the computing environment 300 while supporting the number of simultaneous video communication connections and/or incoming requests for establishing video communication connections. The resource allocation unit 324 may then retrieve, transmit, control, allocate, and/or otherwise distribute determined amount(s) of computing resources to each element (e.g., unit and/or subunit) of the computing environment 300 and/or another computing environment.

In some embodiments, factors affecting the allocation of computing resources by the resource allocation unit 324 may include a volume of video communication connections and/or other communication channel connections, a duration of time during which computing resources are required by one or more elements of the computing environment 300, and/or the like. In some embodiments, computing resources may be allocated to and/or distributed amongst a plurality of second computing environments included in the computing environment 300 based on one or more factors mentioned above. In some embodiments, the allocation of computing resources of the resource allocation unit 324 may include the resource allocation unit 324 flipping a switch, adjusting processing power, adjusting memory size, partitioning a memory element, transmitting data, controlling one or more input and/or output devices, modifying various communication protocols, and/or the like. In some embodiments, the resource allocation unit 324 may facilitate utilization of parallel processing techniques such as dedicating a plurality of GPUs included in the processing unit 302 for processing a high-quality video stream of a video communication connection between multiple units and/or subunits of the computing environment 300 and/or other computing environments.

In some embodiments, the memory unit 304 may be utilized for storing, recalling, receiving, transmitting, and/or accessing various files and/or information during operation of the computing environment 300. The memory unit 304 may include various types of data storage media such as solid state storage media, hard disk storage media, and/or the like. The memory unit 304 may include dedicated hardware elements such as hard drives and/or servers, as well as software elements such as cloud-based storage drives. For example, the memory unit 304 may include various subunits such as an operating system unit 326, an application data unit 328, an application programming interface (API) unit 330, a profile storage unit 332, a content storage unit 334, a video storage unit 336, a secure enclave 338, and/or a cache storage unit 340.

The memory unit 304 and/or any of its subunits described herein may include random access memory (RAM), read only memory (ROM), and/or various forms of secondary storage. RAM may be used to store volatile data and/or to store instructions that may be executed by the processing unit 302. For example, the data stored may be a command, a current operating state of the computing environment 300, an intended operating state of the computing environment 300, and/or the like. As a further example, data stored in the memory unit 304 may include instructions related to various methods and/or functionalities described herein. ROM may be a non-volatile memory device that may have a smaller memory capacity than the memory capacity of a secondary storage. ROM may be used to store instructions and/or data that may be read during execution of computer instructions. In some embodiments, access to both RAM and ROM may be faster than access to secondary storage. Secondary storage may be comprised of one or more disk drives and/or tape drives and may be used for non-volatile storage of data or as an over-flow data storage device if RAM is not large enough to hold all working data. Secondary storage may be used to store programs that may be loaded into RAM when such programs are selected for execution. In some embodiments, the memory unit 304 may include one or more databases for storing any data described herein. Additionally or alternatively, one or more secondary databases located remotely from the computing environment 300 may be utilized and/or accessed by the memory unit 304.

The operating system unit 326 may facilitate deployment, storage, access, execution, and/or utilization of an operating system utilized by the computing environment 300 and/or any other computing environment described herein (e.g., a user device). In some embodiments, the operating system may include various hardware and/or software elements that serve as a structural framework for enabling the processing unit 302 to execute various operations described herein. The operating system unit 326 may further store various pieces of information and/or data associated with operation of the operating system and/or the computing environment 300 as a whole, such as a status of computing resources (e.g., processing power, memory availability, resource utilization, and/or the like), runtime information, modules to direct execution of operations described herein, user permissions, security credentials, and/or the like.

The application data unit 328 may facilitate deployment, storage, access, execution, and/or utilization of an application utilized by the computing environment 300 and/or any other computing environment described herein (e.g., a user device). For example, users may be required to download, access, and/or otherwise utilize a software application on a user device such as a smartphone in order for various operations described herein to be performed. As such, the application data unit 328 may store any information and/or data associated with the application. Information included in the application data unit 328 may enable a user to execute various operations described herein. The application data unit 328 may further store various pieces of information and/or data associated with operation of the application and/or the computing environment 300 as a whole, such as a status of computing resources (e.g., processing power, memory availability, resource utilization, and/or the like), runtime information, modules to direct execution of operations described herein, user permissions, security credentials, and/or the like.

The API unit 330 may facilitate deployment, storage, access, execution, and/or utilization of information associated with APIs of the computing environment 300 and/or any other computing environment described herein (e.g., a user device). For example, computing environment 300 may include one or more APIs for enabling various devices, applications, and/or computing environments to communicate with each other and/or utilize the same data. Accordingly, the API unit 330 may include API databases containing information that may be accessed and/or utilized by applications and/or operating systems of other devices and/or computing environments. In some embodiments, each API database may be associated with a customized physical circuit included in the memory unit 304 and/or the API unit 330. Additionally, each API database may be public and/or private, and so authentication credentials may be required to access information in an API database.

The profile storage unit 332 may facilitate deployment, storage, access, and/or utilization of information associated with user profiles of users by the computing environment 300 and/or any other computing environment described herein (e.g., a user device). For example, the profile storage unit 332 may store one or more user's contact information, authentication credentials, user preferences, user history of behavior, personal information, received input and/or sensor data, and/or metadata. In some embodiments, the profile storage unit 332 may communicate with the profile management unit 310 to receive and/or transmit information associated with a user's profile.

The content storage unit 334 may facilitate deployment, storage, access, and/or utilization of information associated with requested content by the computing environment 300 and/or any other computing environment described herein (e.g., a user device). For example, the content storage unit 334 may store one or more images, text, videos, audio content, advertisements, and/or metadata to be presented to a user during operations described herein. The content storage unit 334 may store contextual features that may be recalled by the features unit 322 during operations described herein. In some embodiments, the contextual features stored in the content storage unit 334 may be associated with numerical values corresponding to predetermined emotions and/or emotional cues. In some embodiments, the content storage unit 334 may communicate with the content management unit 312 to receive and/or transmit content files.

The video storage unit 336 may facilitate deployment, storage, access, analysis, and/or utilization of video content by the computing environment 300 and/or any other computing environment described herein (e.g., a user device). For example, the video storage unit 336 may store one or more live video feeds transmitted during a video communication connection, received user input and/or sensor data, and/or the like. Live video feeds of each user transmitted during a video communication connection may be stored by the video storage unit 336 so that the live video feeds may be analyzed by various components of the computing environment 300 both in real time and at a time after receipt of the live video feeds. In some embodiments, the video storage unit 336 may communicate with the GPUs 316, the facial/vocal recognition unit 318, the gesture analysis unit 320, and/or the features unit 322 to facilitate analysis of any stored video information. In some embodiments, video content may include audio, images, text, video feeds, and/or any other media content.

The secure enclave 338 may facilitate secure storage of data. In some embodiments, the secure enclave 338 may include a partitioned portion of storage media included in the memory unit 304 that is protected by various security measures. For example, the secure enclave 338 may be hardware secured. In other embodiments, the secure enclave 338 may include one or more firewalls, encryption mechanisms, and/or other security-based protocols. Authentication credentials of a user may be required prior to providing the user access to data stored within the secure enclave 338.

The cache storage unit 340 may facilitate short-term deployment, storage, access, analysis, and/or utilization of data. For example, the cache storage unit 348 may serve as a short-term storage location for data so that the data stored in the cache storage unit 348 may be accessed quickly. In some embodiments, the cache storage unit 340 may include RAM and/or other storage media types that enable quick recall of stored data. The cache storage unit 340 may included a partitioned portion of storage media included in the memory unit 304.

As described herein, the memory unit 304 and its associated elements may store any suitable information. Any aspect of the memory unit 304 may comprise any collection and arrangement of volatile and/or non-volatile components suitable for storing data. For example, the memory unit 304 may comprise random access memory (RAM) devices, read only memory (ROM) devices, magnetic storage devices, optical storage devices, and/or any other suitable data storage devices. In particular embodiments, the memory unit 304 may represent, in part, computer-readable storage media on which computer instructions and/or logic are encoded. The memory unit 304 may represent any number of memory components within, local to, and/or accessible by a processor.

The I/O unit 306 may include hardware and/or software elements for enabling the computing environment 300 to receive, transmit, and/or present information. For example, elements of the I/O unit 306 may be used to receive user input from a user via a user device, present a live video feed to the user via the user device, and/or the like. In this manner, the I/O unit 306 may enable the computing environment 300 to interface with a human user. As described herein, the I/O unit 306 may include subunits such as an I/O device 342, an I/O calibration unit 344, and/or video driver 346.

The I/O device 342 may facilitate the receipt, transmission, processing, presentation, display, input, and/or output of information as a result of executed processes described herein. In some embodiments, the I/O device 342 may include a plurality of I/O devices. In some embodiments, the I/O device 342 may include one or more elements of a user device, a computing system, a server, and/or a similar device.

The I/O device 342 may include a variety of elements that enable a user to interface with the computing environment 300. For example, the I/O device 342 may include a keyboard, a touchscreen, a touchscreen sensor array, a mouse, a stylus, a button, a sensor, a depth sensor, a tactile input element, a location sensor, a biometric scanner, a laser, a microphone, a camera, and/or another element for receiving and/or collecting input from a user and/or information associated with the user and/or the user's environment. Additionally and/or alternatively, the I/O device 342 may include a display, a screen, a projector, a sensor, a vibration mechanism, a light emitting diode (LED), a speaker, a radio frequency identification (RFID) scanner, and/or another element for presenting and/or otherwise outputting data to a user. In some embodiments, the I/O device 342 may communicate with one or more elements of the processing unit 302 and/or the memory unit 304 to execute operations described herein. For example, the I/O device 342 may include a display, which may utilize the GPU 316 to present video content stored in the video storage unit 336 to a user of a user device during a video communication connection. The I/O device 342 may also be used to present contextual features to a user during the video communication connection.

The I/O calibration unit 344 may facilitate the calibration of the I/O device 342. For example, the I/O calibration unit 344 may detect and/or determine one or more settings of the I/O device 342, and then adjust and/or modify settings so that the I/O device 342 may operate more efficiently.

In some embodiments, the I/O calibration unit 344 may utilize a video driver 346 (or multiple video drivers) to calibrate the I/O device 342. For example, the video driver 346 may be installed on a user device so that the user device may recognize and/or integrate with the I/O device 342, thereby enabling video content to be displayed, received, generated, and/or the like. In some embodiments, the I/O device 342 may be calibrated by the I/O calibration unit 344 by based on information included in the video driver 346.

The communication unit 308 may facilitate establishment, maintenance, monitoring, and/or termination of communications (e.g., a video communication connection) between the computing environment 300 and other devices such as user devices, other computing environments, third party server systems, and/or the like. The communication unit 308 may further enable communication between various elements (e.g., units and/or subunits) of the computing environment 300. In some embodiments, the communication unit 308 may include a network protocol unit 348, an API gateway 350, an encryption engine 352, and/or a communication device 354. The communication unit 308 may include hardware and/or software elements. In some embodiments, the communication unit 308 may be utilized to initiate audio and/or video conferencing sessions. Alternatively or additionally, the communication unit 308 may facilitate session-less communications, which may entail sending and receiving voicemails, video messages, text messages, and/or image-based messages between or among two or more devices.

The network protocol unit 348 may facilitate establishment, maintenance, and/or termination of a communication connection between the computing environment 300 and another device by way of a network. For example, the network protocol unit 348 may detect and/or define a communication protocol required by a particular network and/or network type. Communication protocols utilized by the network protocol unit 348 may include Wi-Fi protocols, Li-Fi protocols, cellular data network protocols, Bluetooth® protocols, WiMAX protocols, Ethernet protocols, powerline communication (PLC) protocols, Voice over Internet Protocol (VoIP), and/or the like. In some embodiments, facilitation of communication between the computing environment 300 and any other device, as well as any element internal to the computing environment 300, may include transforming and/or translating data from being compatible with a first communication protocol to being compatible with a second communication protocol. In some embodiments, the network protocol unit 348 may determine and/or monitor an amount of data traffic to consequently determine which particular network protocol is to be used for establishing a video communication connection, transmitting data, and/or performing other operations described herein.

The API gateway 350 may facilitate the enablement of other devices and/or computing environments to access the API unit 330 of the memory unit 304 of the computing environment 300. For example, a user device may access the API unit 330 via the API gateway 350. In some embodiments, the API gateway 350 may be required to validate user credentials associated with a user of a user device prior to providing access to the API unit 330 to the user. The API gateway 350 may include instructions for enabling the computing environment 300 to communicate with another device.

The encryption engine 352 may facilitate translation, encryption, encoding, decryption, and/or decoding of information received, transmitted, and/or stored by the computing environment 300. Using the encryption engine, each transmission of data may be encrypted, encoded, and/or translated for security reasons, and any received data may be encrypted, encoded, and/or translated prior to its processing and/or storage. In some embodiments, the encryption engine 352 may generate an encryption key, an encoding key, a translation key, and/or the like, which may be transmitted along with any data content.

The communication device 354 may include a variety of hardware and/or software specifically purposed to enable communication between the computing environment 300 and another device, as well as communication between elements of the computing environment 300. In some embodiments, the communication device 354 may include one or more radio transceivers, chips, analog front end (AFE) units, antennas, processing units, memory, other logic, and/or other components to implement communication protocols (wired or wireless) and related functionality for facilitating communication between the computing environment 300 and any other device. Additionally and/or alternatively, the communication device 354 may include a modem, a modem bank, an Ethernet device such as a router or switch, a universal serial bus (USB) interface device, a serial interface, a token ring device, a fiber distributed data interface (FDDI) device, a wireless local area network (WLAN) device and/or device component, a radio transceiver device such as code division multiple access (CDMA) device, a global system for mobile communications (GSM) radio transceiver device, a universal mobile telecommunications system (UMTS) radio transceiver device, a long term evolution (LTE) radio transceiver device, a worldwide interoperability for microwave access (WiMAX) device, and/or another device used for communication purposes.

It is contemplated that the computing elements be provided according to the structures disclosed herein may be included in integrated circuits of any type to which their use commends them, such as ROMs, RAM (random access memory) such as DRAM (dynamic RAM), and video RAM (VRAM), PROMs (programmable ROM), EPROM (erasable PROM), EEPROM (electrically erasable PROM), EAROM (electrically alterable ROM), caches, and other memories, and to microprocessors and microcomputers in all circuits including ALUs (arithmetic logic units), control decoders, stacks, registers, input/output (I/O) circuits, counters, general purpose microcomputers, RISC (reduced instruction set computing), CISC (complex instruction set computing) and VLIW (very long instruction word) processors, and to analog integrated circuits such as digital to analog converters (DACs) and analog to digital converters (ADCs). ASICS, PLAs, PALs, gate arrays and specialized processors such as digital signal processors (DSP), graphics system processors (GSP), synchronous vector processors (SVP), and image system processors (ISP) all represent sites of application of the principles and structures disclosed herein.

Implementation is contemplated in discrete components or fully integrated circuits in silicon, gallium arsenide, or other electronic materials families, as well as in other technology-based forms and embodiments. It should be understood that various embodiments of the invention can employ or be embodied in hardware, software, microcoded firmware, or any combination thereof. When an embodiment is embodied, at least in part, in software, the software may be stored in a non-volatile, machine-readable medium.

Networked computing environment such as those provided by a communications server may include, but are not limited to, computing grid systems, distributed computing environments, cloud computing environment, etc. Such networked computing environments include hardware and software infrastructures configured to form a virtual organization comprised of multiple resources which may be in geographically disperse locations.

### System Operation

To begin operation of embodiments described herein, a user of a user device may download an application associated with operations described herein to a user device. For example, the user may download the application from an application store or a digital library of applications available for download via an online network. In some embodiments, downloading the application may include transmitting application data from the application data unit 328 of the computing environment 300 to the user device.

Upon download and installation of the application on the user device, the user may select and open the application. The application may then prompt the user via the user device to register and create a user profile. The user may input authentication credentials such as a username and password, an email address, contact information, personal information (e.g., an age, a gender, and/or the like), user preferences, and/or other information as part of the user registration process. This inputted information, as well as any other information described herein, may be inputted by the user of the user device and/or outputted to the user of the user device using the I/O device 342. Once inputted, the information may be received by the user device and subsequently transmitted from the user device to the profile management unit 310 and/or the profile storage unit 332, which receive(s) the inputted information.

In some embodiments, registration of the user may include transmitting a text message (and/or another message type) requesting the user to confirm registration and/or any inputted information to be included in the user profile from the profile management unit 310 to the user device. The user may confirm registration via the user device, and an acknowledgement may be transmitted from the user device to the profile management unit 310, which receives the acknowledgement and generates the user profile based on the inputted information.

After registration is complete, the user may utilize the I/O device 342 to capture an picture of the her or his face. This picture, once generated, may be included in the user profile of the user for identification of the user. In some embodiments, the user may capture an image of her or his face using a camera on the user device (e.g., a smartphone camera, a sensor, and/or the like). In other embodiments, the user may simply select and/or upload an existing image file using the user device. The user may further be enabled to modify the image by applying a filter, cropping the image, changing the color and/or size of the image, and/or the like. Accordingly, the user device may receive the image (and/or image file) and transmit the image to the computing environment 300 for processing. Alternatively, the image may be processed locally on the user device.

In some embodiments, the image may be received and analyzed (e.g., processed) by the facial/vocal recognition unit 318. In some embodiments, the facial/vocal recognition unit 318 may utilize the GPU 316 for analysis of the image. The facial/vocal recognition unit 318 may process the image of the user's face to identify human facial features. Various techniques may be deployed during processing of the image to identify facial features, such as pixel color value comparison. For example, the facial/vocal recognition unit 318 may identify objects of interest and/or emotional cues in the image based on a comparison of pixel color values and/or locations in the image. Each identified object of interest may be counted and compared to predetermined and/or otherwise known facial features included in a database using the facial/vocal recognition unit 318. The facial/vocal recognition unit 318 may determine at least a partial match (e.g., a partial match that meets and/or exceeds a predetermined threshold of confidence) between an identified object of interest and a known facial feature to thereby confirm that the object of interest in the image is indeed a facial feature of the user. Based on a number and/or a location of identified facial features in the image, the facial/vocal recognition unit 318 may determine that the image is a picture of the user's face (as opposed to other subject matter, inappropriate subject matter, and/or the like). In this manner, the facial/vocal recognition unit 318 may provide a layer of security by ensuring that the image included in a user's profile is a picture of the user's face.

Once the facial/vocal recognition unit 318 determines that the image is an acceptable picture of the user's face, the computing environment 300 may store the image in the profile storage unit 332 so that the image may be included in the user's user profile. Conversely, when the facial/vocal recognition unit 318 determines that the image is not an acceptable picture of the user's face (e.g., the image is determined to not be a picture of the user's face), the facial/vocal recognition unit 318 may generate a notification to be sent to and/or displayed by the user device for presentation to the user that explains that the provided image is unacceptable. The user may then repeat the process of capturing an image of her or his face and/or resubmitting an existing image file using the user device. In some embodiments, the user may be prohibited by the computing environment 300 from continuing application use until an image of the user's face is determined by the facial/vocal recognition unit 318 to be legitimate.

As stated above, the image may be processed by the facial/vocal recognition unit 318 on the user device. In other embodiments, the image may be transmitted to another device (e.g., computing environment 300, a third party server, and/or the like) for processing. In some embodiments, any facial features of the user identified by the facial/vocal recognition unit 318 may be stored in the profile storage unit 332 for later recall during analysis of video content of the user.

After registration and generation of the user's profile is complete, the user may initiate, using the user device, a request to begin a video communication connection between the user device and a second user device of another user (or multiple second user devices of multiple second users). For example, in the context of a social media application that enables users to video chat in a speed dating format, the user may initiate a request to be connected to another user of the desired gender (or an unspecified gender) within a predetermined proximity to the determined location of the user's user device. In some embodiments, the request may be initiated by the user using the I/O device 342. For example, the user may perform a gesture recognized by the I/O device 342 (and/or the gesture analysis unit 320), such as holding down a predetermined number of fingers on a touchscreen, to initiate the request.

After initiation, the request may be transmitted to and/or received by the communication unit 308 of the computing environment 300. The request may include connection information such as wireless band information, encryption information, wireless channel information, communication protocols and/or standards, and/or other information required for establishing a video communication connection between the user device and a second user device (or multiple second user devices).

The communication unit 308 may then establish a video communication connection between the user device of the user and the second user device. In some embodiments, establishing the video communication connection may include receiving and/or determining one or more communication protocols (e.g., network protocols) using the network protocol unit 348. For example, the video communication connection may be established by the communication unit 308 using communication protocols included in the request to establish the video communication connection submitted by the user. In some embodiments, the communication unit 308 may establish a plurality of video communication connections simultaneously and/or otherwise in parallel.

In some embodiments, the established video communication connection between the user device of the user and the second user device may be configured by the communication unit 308 to last for a predetermined time duration. For example, according to rules defined by the application and/or stored in the application data unit 328, the video communication connection may be established for a duration of one minute, after which the video communication connection may be terminated. Alternatively, the video communication connection may last indefinitely and/or until one or more of the participating users decides to terminate the video communication connection.

Once the video communication connection has been established by the communication unit 308, the user device and/or the second user device may enable the user and the second user, respectively, to stream a live video and/or audio feed to one another. For example, the user may utilize the I/O device 342 (e.g., a camera and a microphone, a sensor, and/or the like) included in the user device to capture a live video feed of the user's face and voice. Similarly, the second user may utilize the I/O device 342 (e.g., a camera and a microphone, a sensor, and/or the like) included in the second user device to capture a live video feed of the second user's face and voice. In some embodiments, the live video feeds and/or the live audio feeds captured by the user device may be transmitted from the user device to the second user device for display to the second user, and vice versa. In this manner, the user and the second user may communicate by viewing and/or listening to the live video feeds and/or the live audio feeds received from the other user (e.g., the second user and/or the user, respectively) using the established video communication connection.

Additionally, the live video feeds and/or the live audio feeds of the communicating users may be transmitted to and/or received by the computing environment 300 for processing. For example, the GPU 316, the facial/vocal recognition unit 318, the gesture analysis unit 320, and/or the features unit 322 may analyze the live video feeds and/or the live audio feeds. In some embodiments, the GPU 316, the facial/vocal recognition unit 318, the gesture analysis unit 320, and/or the features unit 322 may analyze the live video feeds and/or the live audio feeds to determine which emotions are being communicated by the participating users by way of emotional cues identified in the video feeds and/or the live audio feeds.

Similar to the processes outlined above that are associated with confirming the captured image of the user's face to be included in the user's profile indeed includes only the user's face, the GPU 316 and/or the facial/vocal recognition unit 318 may analyze the live video feeds and/or the live audio feeds to determine that the live video feeds being transmitted between the users by way of the video communication connection include only each user's face. For example, the facial/vocal recognition unit 318 may employ various pixel comparison techniques described herein to identify facial features in the live video feeds of each user to determine whether the live video feeds are indeed appropriate (e.g., do not contain any inappropriate subject matter).

Additionally, the facial/vocal recognition unit 318 may analyze any captured audio of each user. Analysis of captured audio may include vocal recognition techniques so that the identity of each user may be confirmed. Further, the facial/vocal recognition unit 318 may analyze captured audio of each user to identify keywords, changes in vocal pitch and/or vocal tone, and/or other objects of interest (e.g., emotional cues). Particularly, identifying objects of interest such as changes in vocal pitch and/or vocal tone or keywords in a user's speech in this manner may enable the facial/vocal recognition unit 318 to determine whether that user is laughing, crying, yelling, screaming, using sarcasm, and/or is otherwise displaying a particular emotion (e.g., a positive emotion and/or a negative emotion). Additionally, elements of a conversation may be detected in a live audio stream, such as openings, transitions (e.g., a changing of a topic), rebuttals, agreements, conclusions, and/or the like. In this manner, contextual features may be presented to various users at relevant times during a conversation.

If the facial/vocal recognition unit 318 determines any content of the live video feeds and/or the live audio feeds is inappropriate based on its analysis of the live video feeds and/or the live audio feeds, then the communication unit 308 may terminate the video communication connection. For example, if the facial/vocal recognition unit 318 determines that the user's face has left the frame being captured by a video camera and/or a sensor on the user device, the communication unit 308 may terminate and/or otherwise suspend the video communication connection.

Accordingly, any emotional cues identified by the facial/vocal recognition unit 318 (e.g., facial features, a vocal identity, and/or the like) may be analyzed by the gesture analysis unit 320. In some embodiments, the gesture analysis unit 320 may compare identified objects of interest (e.g., emotional cues) over time. For example, the gesture analysis unit 320 may determine an amount of movement of one or more facial features based on pixel locations of identified facial features, a change in color of one or more facial features, a change in vocal inflection, vocal pitch, vocal phrasing, rate of speech delivery, and/or vocal tone, and/or the like. The gesture analysis unit 320 may, based on the analysis of the live video feeds and/or the live audio feeds, determine one or more gestures performed by the user and/or the second user. For example, based on determining that both corners of the user's lips moved upwards in relation to other identified facial features, the gesture analysis unit 320 may determine that the user is smiling. In some embodiments, the gesture analysis unit 320 may determine a gesture has been performed by a user based on a combination of factors such as multiple facial feature movements, vocal inflections, speaking of keywords, and/or the like. In some embodiments, the gesture analysis unit 320 may determine a gesture has been performed based on determining at least a partial match between identified facial feature movements, vocal changes, and/or the like and a predetermined gesture patterns stored in a database (e.g., stored in memory unit 304).

Each identified gesture (e.g., emotional cue) may next be assigned a numerical value associated with a predetermined emotion by the gesture analysis unit 320 and/or the features unit 322. For example, an identified smile gesture may be assigned a positive numerical value, whereas an identified frown gesture may be assigned a negative numerical value. Additionally and/or alternatively, the gesture analysis unit 320 and/or the features unit 322 may assign different weights to the numerical values of different identified gestures. For example, a numerical value associated with an identified large smile gesture might be weighted by the gesture analysis unit 320 and/or the features unit 322 more heavily than a numerical value associated with an identified small smirk gesture.

As described herein, each numerical value associated with identified gestures (e.g., emotional cues) may correspond to a particular emotion. Additionally, the numerical value assigned to identified gestures may correspond to contextual features stored in the content storage unit 334. Foe example, identified gestures that are assigned a numerical value greater than a predetermined threshold value may correspond to a particular set of contextual features stored in the content storage unit 334 and associated with a particular emotion that may be represented by the identified gestures. As such, the features unit 322 and/or the content management unit 312 may utilize the numerical values assigned to identified gestures to identify and/or select one or more contextual features stored in the content storage unit 334. In this manner, contextual features that are relevant to emotions demonstrated by the participating users may be identified and subsequently presented to the user for use.

In addition, contextual features may be identified as relevant (e.g., of interest) to a video communication connection based on location. In some embodiments, the location determination unit 314 may determine the location of the user device of the user (and therefore the user) using various location-based techniques. For example, the location determination unit 314 may determine GPS coordinates, an IP address, a proximity to a predetermined location, a nearest zip code, and/or the like of the user device using one or more sensors and/or locationally-purposed hardware described herein. Alternatively, a live video feed and/or a live audio feed transmitted during the video communication connection may be analyzed for particular locational cues, such as landmarks, objects of interest, scenery, seasons, weather, time of day, buildings or structures, speech accents, dialects, languages, environmental noise, and/or the like. For example, the location determination unit 314, the GPU 316, the facial/vocal recognition unit 318, the gesture analysis unit 320, and/or the features unit 322 may identify one or more locational cues included in the live video feed of the user (e.g., background objects, foreground objects, an accent of a user, and/or the like) and determine at least a partial match between identified objects of interest (e.g., locational cues) and predetermined landmarks, images, buildings, people, accents, street names, and/or the like associated with a known location. In this manner, the location determination unit 314 may determine the location of the user device (and thus the user). Locational cues may be associated with geographic locations, as well as environment-based cues such as seasons, weather, temperature, objects detected in the background of a live video feed and/or a live audio feed, colors, and/or the like.

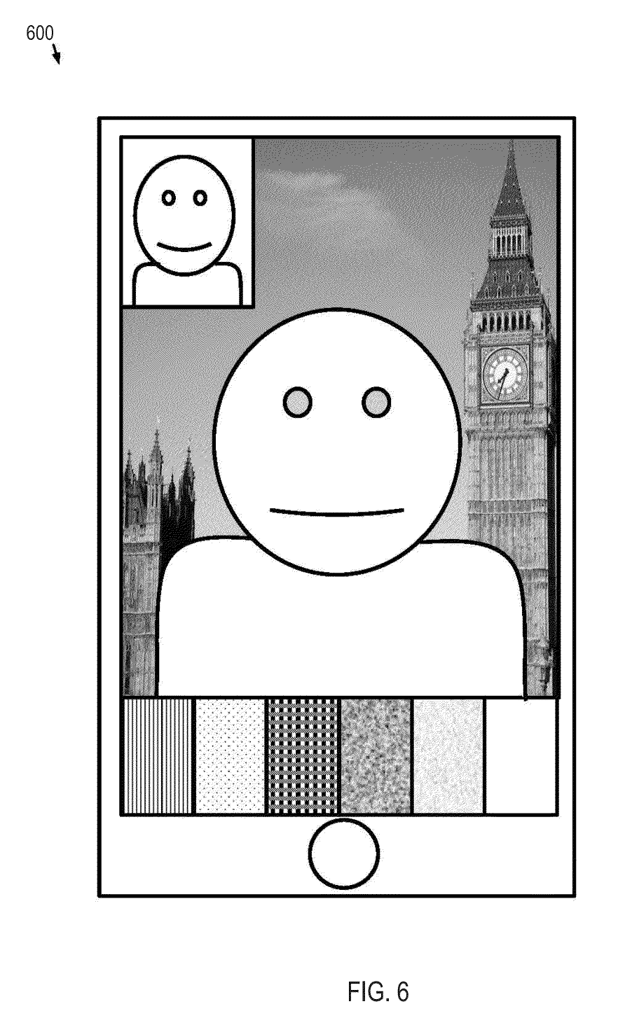

The content management unit 312 and/or the features unit 322 may then identify one or more contextual features relevant to the determined location of the user (e.g., relevant to the identified locational cues and/or objects of interest). For example, via analysis of live video feed of a user, the location determination unit 314, the facial/vocal recognition unit 318, the gesture analysis unit 320, and/or the features unit 322 may identify a recognizable landmark, such as the Big Ben clock tower in London, in the background of the live video feed (see exemplary user interface 600 of FIG. 6). Accordingly, the location determination unit 314 may determine that the user is located in London. The features unit 322 may then identify and/or select one or more features relevant to London in the content storage unit 334 for presentation to the user. In some embodiments, location information of the user's user device may be stored by the computing environment 300 in the profile storage unit 332 so that it may be included in the user's user profile.

In some embodiments, the I/O device 342 may include and/or utilize depth sensors that may determine depth information for each pixel and/or a sub-sampled set of pixels in a live video stream. Depth information captured by depth sensors may be used to distinguish which pixels are to be associated with foreground objects (e.g., the users) and which pixels are to be associated with the background, so the features unit 322 may be aware of which pixels need to be modified.

In some embodiments, the background overlay behind the recipient may be selected as the real-time background behind the caller, such that the caller and recipient may appear to be in the same environment. This option may, for example, be presented for selection by the caller or the recipient if it is detected that either the caller or the recipient is away from their normal location and a decision engine and/or emotion detection engine detects sadness, which may be indicative of homesickness.

As described herein, the features unit 322 and/or the content management unit 312 may present to the user contextual features identified as relevant to the user's emotions and/or location. In some embodiments, the relevant contextual features may be presented to the user in a toolbar, a menu, and/or other portion of a user interface. Selecting a contextual feature for incorporation into the video communication may include overlaying a live video feed and/or a live audio feed with an image, text, an icon, an audio clip, and/or the like. Additionally and/or alternatively, selecting a contextual feature for incorporation into the video communication connection may include replacing an image of a user in the live video stream (e.g., visually overlaying in real time) with an icon, a static image, an animated image, text, an avatar or a cartoon, digital apparel, a shape, a filter, a color, a sticker, a video stream, and/or the like. For example, exemplary user interface 500 of FIG. 5 illustrates an duck avatar that has replaced the image of a user in the live video stream. Selecting a contextual feature for incorporation into the video communication may further include masking and/or modifying a live audio feed of a user by modulating the user's voice with a phaser, a compressor, a flanger, a delay, a reverb, a pitch shifter, a filter, and/or the like. Selecting a contextual feature for incorporation into the video communication may also include changing, modifying, and/or augmenting a background image of the live video feed with a pattern with an image of a particular setting or location (e.g., a beach setting, a skyscraper skyline, a rainforest, and/or the like), and/or the like. Typically, selecting a contextual feature includes transforming the visual and/or auditory appearance of a user and may be selected and/or determined to be relevant based on an identified environment of a user, a determined location of a user, and/or the like.

In some embodiments, the features unit 322 may track, using one or more sensors described herein, the location of facial features, body parts, and/or the like so that any overlaid contextual features may closely follow the actions of the users and thus appear animated. For example, when a user smiles, an image of a dinosaur that has been overlaid the image of the user in the live video feed of the user may smile as well (e.g., using the user's detected smile as a reference). As another example, a smiley face icon may “follow” the movements of a user's face in the live video feed, so that when a user moves his head within the frame of the live video feed, the smiley face icon stays overlain on the user's face. In some embodiments, the user may place a contextual feature at a desired location in the video communication connection (e.g., in the live video feed), and the contextual feature may be presented in the video communication connection on one or more user devices. For example, the user may place an image of digital apparel at a fixed point on a body of a user in the live video feed. The digital apparel image may maintain the position of a fixed point or points on the receipts body, and a selected piece of digital apparel may be mapped and overlaid with respect to the fixed point(s), such that the apparel may appear to actually be attached to the recipient.

In some embodiments, the feature unit 322 may automatically select one or more contextual features to be incorporated into the video communication connection. Alternatively, the feature unit 322 may identify and/or select one or more contextual features to be presented to the user for selection by the user. The selected contextual features may then be incorporated into the video communication connection in real time (e.g., during transmission of the live video feed and/or the live audio feed) by one or more participating users. The same contextual features may be presented to each participating user and/or groups of participating users, or different contextual features may be presented to each participating user and/or groups of participating users. If the user does not wish to select any of the presented contextual features, the user may request a new set of contextual features, perform a search for other contextual features and/or images on the Internet, and/or the like. The user may also be enabled to upload, import, and/or otherwise use a photo or other contextual image that is saved locally to the user's user device. In some embodiments, the users may choose to enable or disable automatic presentation of contextual features.

Once a contextual feature is selected by the feature unit 322 and/or a user, the feature unit 322 may then present other users (and/or the same user) other contextual features that are related to the selected contextual feature. The other contextual features may include a set of selectable features that may be relevant as a direct or indirect response to the selected contextual feature. Accordingly, these other contextual features, if selected for presentation, may help drive a conversation between users. A working database storing the features on any or all of the users' devices, such as the content storage unit 334 and/or the cache storage unit 340, may also store information associated with relationships between contextual features to enable more rapid incorporation.

In some embodiments, the feature unit 322 may identify one or more activities associated with a user based on an analysis of the user's live video feed and/or live audio feed. For example, the feature unit 322 may determine, based on various objects of interest determined to be included in the live video feed of the user by the facial/vocal recognition unit 318 and/or the gesture analysis unit 320, that a user is exercising, at an event, moving in a transport vehicle, and/or the like. Other data, such as sensor data captured by an accelerometer included in the user's user device, may be utilized to determine one or more activities being performed by the user. As such, the features unit 322 may identify one or more contextual features to be presented to the user based on an identified activity being performed by the user (e.g., activity cues).

Clocks and timers may also provide valuable data for analysis by the gesture analysis unit 320 and/or the features unit 322. For example, a season and/or time of day may provide context for certain contextual features. These aspects may be useful when one or both users indicate (e.g., based on an analysis of each user's live video feed) boredom and could use new and relevant material to reinvigorate their conversation. The length of duration of an ongoing conversation and/or video communication connection may also establish valuable contextual information to be used in determining relevance of an identified contextual feature and/or emotional cue.

In some embodiments, the features unit 322 may utilize “orthogonal” types of information, such as both locational cues and emotional cues, that do not necessarily conflict with one another. When the features unit 322 determines orthogonal contexts, the features unit 322 may serve features that are at the intersection of both (or all) contexts, if possible. For example, the features unit 322 may search the content storage unit 334 for, identify, and/or select contextual features having tags relating to both (or all) orthogonal contexts. Alternatively, the features unit may identify and/or select contextual features relating to a dominant context (e.g., only locational cues), which may be perceived as more relevant or likely to contribute to the conversation (e.g., by being more interesting or extraordinary) based on a relevance score.

While many embodiments described herein are presented in the context of two users, it is to be understood that the disclosed principles may also apply to group conferencing sessions having more than two users. In embodiments with many users, contextual features may be presented based on emotional cues, locational cues, activity cues, and/or other information relating to individual users or generally to the group as a whole. For example, if the gesture analysis unit 320 determines that many or most users in a video communication connection are detected as being excited, one or more users may receive contextual feature suggestions responsive to the excitement, such as an avatar of a anthropomorphized lightning bolt that may be applied to one or more (or all) users within the video communication connection or an icon urging users to calm down.

In some embodiments, the live video feed and/or the live audio feed may be transmitted to another computing device for processing. For example, the communication unit 308 may transmit a live video feed of a video communication connection and/or sensor data received from a user device to a third party video processing engine (e.g., a decision engine) for processing. The communication unit 308 may then receive processed video content and/or results of processing such identification of a location of a user device, identification of (e.g., a numerical value associated with) an emotion of a user identified based on an analysis of video content and/or a user history of the user, and/or the like.

In some embodiments, the user (e.g., the users described herein, an administrator, and/or the like) may be enabled to add, delete, and/or modify various elements for the processing unit 302 and/or the memory unit 304 to identify and/or store, respectively. For example, a user may add a new emotion to be detected and/or a new geographic location to be recognized through video content analysis. The computing environment 300 may also be enabled, through machine learning techniques and/or database updates, to learn, modify, and/or refine its database of known and/or predetermined emotions, gestures, facial features, objects of interest, locational cues, emotional cues, and/or the like. Additionally, the computing environment 300 (and particularly, the features unit 322) may update its numerical valuing and/or weighting techniques based on popularity, frequency of use, and/or other factors associated with the aforementioned database of known and/or predetermined emotions, gestures, facial features, objects of interest, locational cues, emotional cues, and/or the like. In this manner, the computing environment 300 may be regularly updated with new information so as to provide more relevant, tailored communication experience enhancements. Further, emotional cues, locational cues, activity cues, and/or identified contextual features may be prioritized by a user and/or by the feature unit 322.

In some embodiments, the features unit 322 may generate a relevance score associated with each identified emotional cue, locational cue, and/or a contextual feature (and/or any other identified object of interest). The relevance score may correspond to a level of confidence in that each identified emotional cue, locational cue, and/or contextual feature is indeed relevant to a conversation enabled by the video communication connection. In this manner, the relevance score may communicate how strongly or intensely an emotion, location, and/or other object was sensed and/or perceived. Accordingly, the relevance score of each identified emotional cue, locational cue, and/or contextual feature may be presented to the user so that the user may consider the relevance score before selecting an associated contextual feature for incorporation into the video communication connection. Alternatively, the features unit 322 may be configured to only select contextual features whose relevance score meets and/or exceeds a predetermined threshold value.

In some embodiments, the application data stored in the application data unit 328 and/or the API unit 330 may enable the application described herein to interface with social media applications. For example, a user may be enabled to import contact information and/or profile information from a social media application so that the user may establish video communication connections with existing contacts. The communication unit 320 may further enable the user to communicate in various communication channels such as text messaging, video chatting, picture sharing, audio sharing, and/or the like.

In some embodiments, the profile management unit 310 may further enable purchase of virtual currency, facilitate the transfer of real monetary funds between bank accounts, and/or the like. Additionally, the profile management unit 310 may track behavior of the user and may provide rewards, such as virtual currency, based on actions performed by the user during operation of the application. At various times throughout operation of the application described herein, advertisements and/or notifications of performed actions may be presented to each of the users by the content management unit 312.

Further, the disclosed embodiments may apply to many different channels of communication beyond video communication connections (e.g., conferencing sessions). In some embodiments, the communications media may be text and/or graphical messaging between individuals, which may or may not entail discrete conferencing sessions and may instead take place perpetually. In these embodiments, different algorithms and/or techniques, such as text analysis, may be used by the facial/vocal recognition unit 318, the gesture analysis unit 320, and/or the features unit 322 to discern emotions. In some embodiments, the disclosed embodiments may apply to audio conferencing sessions. In embodiments involving audio data, factors such as pitch, cadence, and/or other aspects of speech or background noise may be analyzed by the facial/vocal recognition unit 318, the gesture analysis unit 320, and/or the features unit 322 to discern emotions and other contextual information. Some sensors, such as location sensors, associated with the location determination unit 314 may be equally relevant and applicable across the different communications media.

The types of contextual features presented to a user may vary based on the selected communications media. For example, if a first user is connected to other users in an audio conferencing session, the first user may be presented with contextual sound clips and/or acoustic filters that the first user may apply to the conversation. If users are communicating with one another over an image- and/or text-based channel, a user may be presented with images, fonts, and other types of contextual features that can add value to the conversation based on perceived contexts.

### Method Descriptions

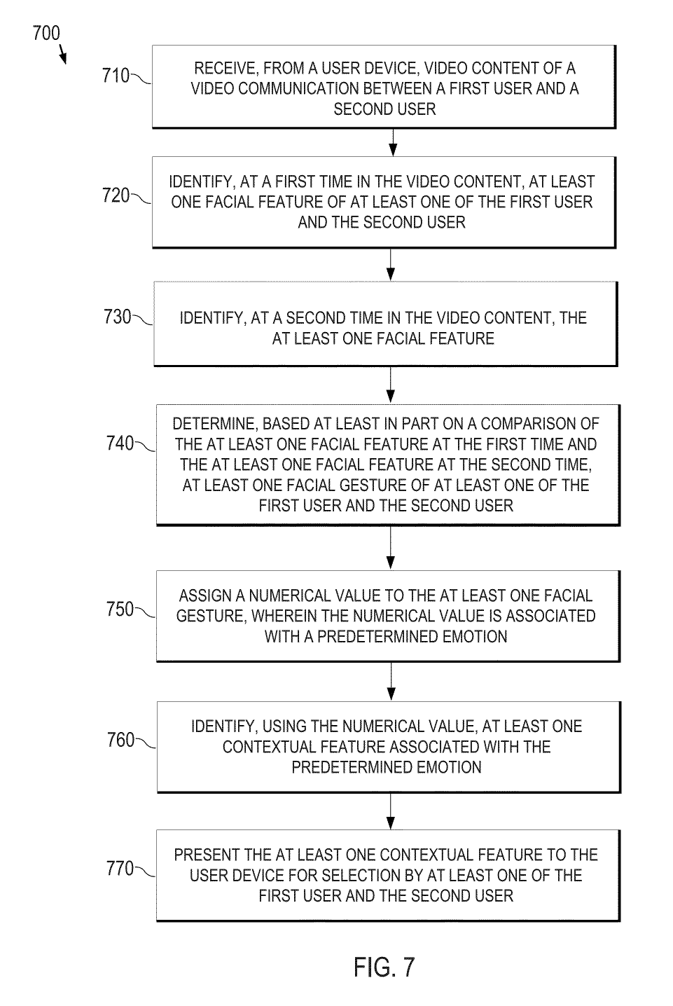

FIG. 7 shows an exemplary method 700 for performing operations associated with identifying contextual features based on emotion as described herein. At block 710, the method 700 may include receiving, from a user device, video content of a video communication between a first user and a second user. At block 720, the method 700 may include identifying, at a first time in the video content, at least one facial feature of at least one of the first user and the second user. At block 730, the method 700 may include identifying, at a second time in the video content, the at least one facial feature. At block 740, the method 700 may include determining, based at least in part on a comparison of the at least one facial feature at the first time and the at least one facial feature at the second time, at least one facial gesture of at least one of the first user and the second user. At block 750, the method 700 may include assigning a numerical value to the at least one facial gesture, wherein the numerical value is associated with a predetermined emotion. At block 760, the method 700 may include identifying, using the numerical value, at least one contextual feature associated with the predetermined emotion. At block 770, the method 700 may include presenting the at least one contextual feature to the user device for selection by at least one of the first user and the second user.

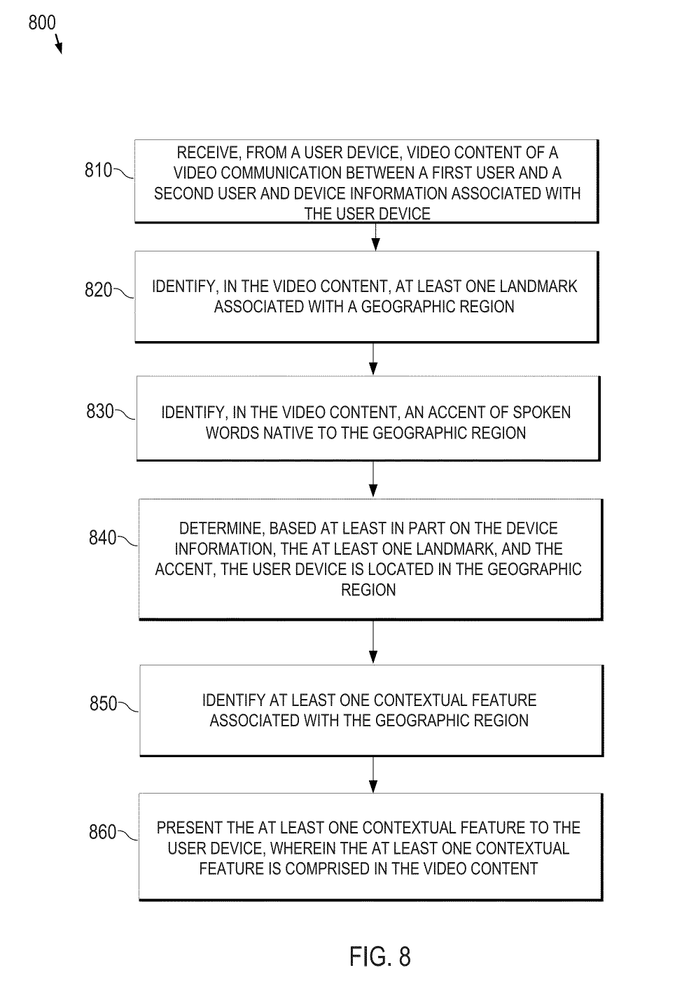

FIG. 8 shows an exemplary method 800 for performing operations associated with identifying contextual features based on location as described herein. At block 810, the method 800 may include receiving, from a user device, video content of a video communication between a first user and a second user and device information associated with the user device. At block 820, the method 800 may include identifying, in the video content, at least one landmark associated with a geographic region. At block 830, the method 800 may include identifying, in the video content, an accent of spoken words native to the geographic region. At block 840, the method 800 may include determining, based at least in part on the device information, the at least one landmark, and the accent, the user device is located in the geographic region. At block 850, the method 800 may include identifying at least one contextual feature associated with the geographic region. At block 860, the method 800 may include presenting the at least one contextual feature to the user device, wherein the at least one contextual feature is comprised in the video content.

### Disclaimers

While various implementations in accordance with the disclosed principles have been described above, it should be understood that they have been presented by way of example only, and are not limiting. Thus, the breadth and scope of the implementations should not be limited by any of the above-described exemplary implementations, but should be defined only in accordance with the claims and their equivalents issuing from this disclosure. Furthermore, the above advantages and features are provided in described implementations, but shall not limit the application of such issued claims to processes and structures accomplishing any or all of the above advantages.

Various terms used herein have special meanings within the present technical field. Whether a particular term should be construed as such a “term of art,” depends on the context in which that term is used. “Connected to,” “in communication with,” “communicably linked to,” “in communicable range of” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the implementations set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any implementations in this disclosure. Neither is the “Summary” to be considered as a characterization of the implementations set forth in issued claims. Furthermore, any reference in this disclosure to “implementation” in the singular should not be used to argue that there is only a single point of novelty in this disclosure. Multiple implementations may be set forth according to the limitations of the multiple claims issuing from this disclosure, and such claims accordingly define the implementations, and their equivalents, that are protected thereby. In all instances, the scope of such claims shall be considered on their own merits in light of this disclosure, but should not be constrained by the headings herein.

Lastly, although similar reference numbers may be used to refer to similar elements for convenience, it can be appreciated that each of the various example implementations may be considered distinct variations.

What is claimed is:

1. A video communication server comprising:
at least one memory comprising instructions; and
at least one processing device configured for executing the instructions, wherein the instructions cause the at least one processing device to perform the operations of:
receiving, using a communication unit comprised in the at least one processing device, video content of a video communication connection between a first user of a first user device and a second user of a second user device;
analyzing, using a graphical processing unit (GPU) comprised in the at least one processing device, the video content in real time;
identifying, using a recognition unit comprised in the at least one processing device, at least one object of interest comprised in the video content;
identifying, using a features unit comprised in the least one processing device, at least one contextual feature associated with the at least one identified object of interest; and
presenting, using an input/output (I/O) device, the at least one contextual feature to at least one of the first user device and the second user device.

2. The video communication server of claim 1, wherein the at least one object of interest comprises at least one of a facial feature, a facial gesture, a vocal inflection, a vocal pitch shift, a change in word delivery speed, a keyword, an ambient noise, an environment noise, a landmark, a structure, a physical object, and a detected motion.

3. The video communication server of claim 1, wherein identifying the at least one object of interest comprises:
identifying, using the recognition unit, a facial feature of the first user in the video content at a first time;
identifying, using the recognition unit, the facial feature of the first user in the video content at a second time; and
determining, using the recognition unit, movement of the facial feature from a first location at a first time to a second location at a second time,
wherein the determined movement of the facial feature comprises a gesture associated with a predetermined emotion, and
wherein the at least one contextual feature is associated with the predetermined emotion.

4. The video communication server of claim 1, wherein identifying the at least one object of interest comprises:
identifying, using the recognition unit, a first vocal pitch of the first user in the video content at a first time;
identifying, using the recognition unit, a second vocal pitch of the first user in the video content at a second time; and
determining, using the recognition unit, a change of vocal pitch of the first user,
wherein the determined change of vocal pitch comprises a gesture associated with a predetermined emotion, and
wherein the at least one contextual feature is associated with the predetermined emotion.

5. The video communication server of claim 1, wherein identifying the at least one object of interest comprises:
identifying, using the recognition unit, a landmark in the video content, wherein the landmark is associated with a geographic region;
identifying, using the recognition unit, a speaking accent of the first user in the video content, wherein the accent is associated with the geographic region; and
determining, using the recognition unit and based at least in part on the landmark and the accent, the first user device is located in the geographic region,
wherein the at least one contextual feature is associated with the geographic region.

6. The video communication server of claim 1, wherein presenting the at least one contextual feature to at least one of the first user device and the second user device comprises:
identifying, using the recognition unit, at least one reference point in the video content;
tracking, using the recognition unit, movement of the at least one reference point in the video content; and
overlaying, using the features unit, the at least one contextual feature onto the at least one reference point in the video content.

7. The video communication server of claim 1, wherein identifying the at least one object of interest comprises:
determining, using the GPU, a numerical value of at least one pixel associated with the at least one object of interest.

8. A non-transitory computer readable medium comprising code, wherein the code, when executed by at least one processing device of a video communication server, causes the at least one processing device to perform the operations of:
receiving, using a communication unit comprised in the at least one processing device, video content of a video communication connection between a first user of a first user device and a second user of a second user device;
analyzing, using a graphical processing unit (GPU) comprised in the at least one processing device, the video content in real time;
identifying, using a recognition unit comprised in the at least one processing device, at least one object of interest comprised in the video content;
identifying, using a features unit comprised in the least one processing device, at least one contextual feature associated with the at least one identified object of interest; and
presenting, using an input/output (I/O) device, the at least one contextual feature to at least one of the first user device and the second user device.

9. The non-transitory computer readable medium of claim 8, wherein the at least one object of interest comprises at least one of a facial feature, a facial gesture, a vocal inflection, a vocal pitch shift, a change in word delivery speed, a keyword, an ambient noise, an environment noise, a landmark, a structure, a physical object, and a detected motion.

10. The non-transitory computer readable medium of claim 8, wherein the non-transitory computer readable medium further comprises code that, when executed by the at least one processing device of the video communication server, causes the at least one processing device to perform the operations of:
identifying, using the recognition unit, a facial feature of the first user in the video content at a first time;
identifying, using the recognition unit, the facial feature of the first user in the video content at a second time; and
determining, using the recognition unit, movement of the facial feature from a first location at a first time to a second location at a second time,
wherein the determined movement of the facial feature comprises a gesture associated with a predetermined emotion, and
wherein the at least one contextual feature is associated with the predetermined emotion.

11. The non-transitory computer readable medium of claim 8, wherein the non-transitory computer readable medium further comprises code that, when executed by the at least one processing device of the video communication server, causes the at least one processing device to perform the operations of:
identifying, using the recognition unit, a first vocal pitch of the first user in the video content at a first time;
identifying, using the recognition unit, a second vocal pitch of the first user in the video content at a second time; and
determining, using the recognition unit, a change of vocal pitch of the first user,
wherein the determined change of vocal pitch comprises a gesture associated with a predetermined emotion, and
wherein the at least one contextual feature is associated with the predetermined emotion.

12. The non-transitory computer readable medium of claim 8, wherein the non-transitory computer readable medium further comprises code that, when executed by the at least one processing device of the video communication server, causes the at least one processing device to perform the operations of:
identifying, using the recognition unit, a landmark in the video content, wherein the landmark is associated with a geographic region;
identifying, using the recognition unit, a speaking accent of the first user in the video content, wherein the accent is associated with the geographic region; and
determining, using the recognition unit and based at least in part on the landmark and the accent, the first user device is located in the geographic region,
wherein the at least one contextual feature is associated with the geographic region.

13. The non-transitory computer readable medium of claim 8, wherein the non-transitory computer readable medium further comprises code that, when executed by the at least one processing device of the video communication server, causes the at least one processing device to perform the operations of:
identifying, using the recognition unit, at least one reference point in the video content;
tracking, using the recognition unit, movement of the at least one reference point in the video content; and
overlaying, using the features unit, the at least one contextual feature onto the at least one reference point in the video content.

14. The non-transitory computer readable medium of claim 8, wherein the non-transitory computer readable medium further comprises code that, when executed by the at least one processing device of the video communication server, causes the at least one processing device to perform the operations of:
determining, using the GPU, a numerical value of at least one pixel associated with a facial feature identified in the video content.

15. A method comprising:
receiving, using a communication unit comprised in at least one processing device, video content of a video communication connection between a first user of a first user device and a second user of a second user device;
analyzing, using a graphical processing unit (GPU) comprised in the at least one processing device, the video content in real time;
identifying, using a recognition unit comprised in the at least one processing device, at least one object of interest comprised in the video content;
identifying, using a features unit comprised in the least one processing device, at least one contextual feature associated with the at least one identified object of interest; and
presenting, using an input/output (I/O) device, the at least one contextual feature to at least one of the first user device and the second user device.

16. The method of claim 15, wherein the at least one object of interest comprises at least one of a facial feature, a facial gesture, a vocal inflection, a vocal pitch shift, a change in word delivery speed, a keyword, an ambient noise, an environment noise, a landmark, a structure, a physical object, and a detected motion.

17. The method of claim 15, wherein the method further comprises:
identifying, using the recognition unit, a facial feature of the first user in the video content at a first time;
identifying, using the recognition unit, the facial feature of the first user in the video content at a second time; and
determining, using the recognition unit, movement of the facial feature from a first location at a first time to a second location at a second time,
wherein the determined movement of the facial feature comprises a gesture associated with a predetermined emotion, and
wherein the at least one contextual feature is associated with the predetermined emotion.

18. The method of claim 15, wherein the method further comprises:
identifying, using the recognition unit, a first vocal pitch of the first user in the video content at a first time;
identifying, using the recognition unit, a second vocal pitch of the first user in the video content at a second time; and
determining, using the recognition unit, a change of vocal pitch of the first user, wherein the determined change of vocal pitch comprises a gesture associated with a predetermined emotion, and
wherein the at least one contextual feature is associated with the predetermined emotion.

19. The method of claim 15, wherein the method further comprises:
identifying, using the recognition unit, a landmark in the video content, wherein the landmark is associated with a geographic region;
identifying, using the recognition unit, a speaking accent of the first user in the video content, wherein the accent is associated with the geographic region; and
determining, using the recognition unit and based at least in part on the landmark and the accent, the first user device is located in the geographic region,
wherein the at least one contextual feature is associated with the geographic region.

20. The method of claim 15, wherein the method further comprises:
identifying, using the recognition unit, at least one reference point in the video content;
tracking, using the recognition unit, movement of the at least one reference point in the video content; and
overlaying, using the features unit, the at least one contextual feature onto the at least one reference point in the video content.
